(19) United States
(12) Patent Application Publication
(10) Pub. No.: US 2005/0012916 A1
(43) Pub. Date: Jan. 20, 2005

(54) Lithographic apparatus and device manufacturing method

(76) Inventors: Karel Diederick Van Der Mast, Helmond (NL); Arno Jan Bleeker, Westerhoven (NL); Cheng-Qun Gui, Best (NL); Johan Christiaan Gerard Hoefnagels, Hooge Mierde (NL)

Correspondence Address: STERNE, KESSLER, GOLDSTEIN & FOX PLLC, 1100 NEW YORK AVENUE, N.W., WASHINGTON, DC, 20005, US

(21) Appl. No.: 10/850,567

(22) Filed: May 21, 2004

(30) Foreign Application Priority Data
May 22, 2003 (EP) 03253213.7

(51) Int. Cl. G03B 27/54

(52) U.S. Cl. 355/67; 355/53

(57) ABSTRACT

A lithographic projection apparatus comprises a microlens array for generating a plurality of source images in a two-dimensional array, a programmable patterning means having a plurality of addressable elements acting as shutters for the source images and a projection subsystem for projecting a n image of the array of source images onto a substrate. A greater working distance can thereby be obtained

### BACKGROUND OF THE INVENTION

1. Field of the Invention

The present invention relates to a lithographic projection apparatus and device manufacturing method.

2. Related Art

Lithographic projection apparatus can be used, for example, in the manufacture of devices on substrates. For example, a lithographic projection apparatus can be used for the manufacture of integrated circuits (ICs). In such a case, the programmable patterning means can generate a circuit pattern corresponding to an individual layer of the IC, and this pattern can be imaged onto a target portion (e.g., comprising one or more dies) on a substrate (e.g., a silicon wafer) that has been coated with a layer of radiation-sensitive material (e.g., resist).

In general, a single wafer will contain a whole network of adjacent target portions that are successively irradiated via the projection system, one at a time. In apparatus employing patterning by a mask on a mask table, a distinction can be made between two different types of machine. In one type of lithographic projection apparatus, each target portion is irradiated by exposing the entire mask pattern onto the target portion in one go. This is referred to as a wafer stepper. In an alternative apparatus referred to as a step-and-scan apparatus, each target portion is irradiated by progressively scanning the mask pattern under the projection beam in a given reference direction (the “scanning” direction), while synchronously scanning the substrate table parallel or anti-parallel to this direction. In general, the projection system will have a magnification factor M (generally<1), the speed V at which the substrate table is scanned will be a factor M times that at which the mask table is scanned.

In a manufacturing process using a lithographic projection apparatus, a pattern (e.g., in a mask) is imaged onto a substrate that is at least partially covered by a layer of radiation-sensitive material (e.g., resist). Prior to this imaging step, the substrate can undergo various procedures, such as priming, resist coating, and a soft bake. After exposure, the substrate can be subjected to other procedures, such as a post-exposure bake (PEB), development, a hard bake, and measurement/inspection of the imaged features. These procedures are used as a basis to pattern an individual layer of a device, e.g. an IC. Such a patterned layer can then undergo various processes such as etching, ion-implantation (doping), metallization, oxidation, chemo-mechanical polishing, etc., all intended to finish off an individual layer. If several layers are required, then the whole procedure, or a variant thereof, will have to be repeated for each new layer. Eventually, an array of devices will be present on the substrate (e.g., wafer). These devices are then separated from one another by a technique such as dicing or sawing, whence the individual devices can be mounted on a carrier, connected to pins, etc.

Some lithographic systems utilize a microlens array (MLA) to process patterned light. A system employing a microlens array (MLA) can include a light source having a beam of radiation that is directed via a beam splitter onto a spatial light modulator (SLM), constituted by a digital micro-mirror array. The individual mirrors of the array can be set to either direct light out of the system or back through the beam splitter to a projection lens system, which projects an image of the SLM onto a microlens array MLA. The MLA might have microlenses in 1:1 relationship with the individual mirrors of the spatial light modulator. Each lens of the MLA images the projection aperture onto a respective spot on a substrate. Thus, an array of spots on the substrate can be selectively exposed according to the setting of the corresponding mirror in the SLM and by scanning the substrate, the whole surface thereof can be selectively exposed.

The above system has a small working distance, which is determined by the focal length of the microlenses and can be less than 1 mm, between the MLA and the substrate. A small working distance is a drawback, and causes problems, such as increased potential for contamination of the microlens array and increased potential for collisions between substrate and the microlens array. Also, little space is available for sensors, such as height and tilt sensors, which are used for leveling control during scanning exposures.

Therefore, what is needed is a lithographic projection apparatus employing a programmable patterning device and a microlens that has a large working distance relative to a conventional lithographic projection apparatus.

### SUMMARY OF THE INVENTION

One embodiment of the present invention provides a lithographic projection apparatus comprising an illumination system for supplying a projection beam of radiation, a programmable patterning device comprising a plurality of addressable elements and capable of being set in accordance with a desired pattern, a substrate table for holding a substrate, a projection system for transferring the desired pattern onto a target portion of the substrate. The projection system comprises a microlens array having a plurality of microlenses corresponding to the addressable elements of the programmable patterning device and for forming an array of source images, and a projection subsystem for projecting an image of the array of source images onto the substrate.

In this embodiment, the working distance is no longer limited by the focal length of the microlens array, but rather can be set with much greater freedom by appropriate design of the projection subsystem. The projection subsystem can be a (refractive) lens system of known type and can project a 1:1 or reduced image of the source image array.

In one example, the illumination system delivers a substantially collimated beam of radiation to the microlens array, which forms the array of source images therefrom. The programmable patterning device is a selectively transmissive device (e.g., an LCD array) positioned proximate to the microlens array, whereby addressable elements of the programmable patterning device can be set to block respective ones of the source images. This provides a simple, robust system. To minimize absorption by inactive parts of the programmable patterning device, the programmable patterning device is placed close to the plane of the source images, so that each of the beams fits within the transmissive part of each addressable element of the programmable patterning device.

In another example, the projection system further comprises a second projection subsystem for projecting an image of the programmable patterning device onto the microlens array. The second projection subsystem can be a (refractive) lens system of known type and provides additional flexibility of design of the apparatus. For example, by designing the second projection subsystem with appropriate magnification or reduction, it becomes possible to use a programmable patterning device and a microlens arrays of different scales.

In one example, the microlens array can be arranged to project the source images onto a spherical surface. This allows the size of the elements making up the projection subsystem to be reduced.

Another embodiment of the present invention a device manufacturing method comprises the steps of providing a substrate that is at least partially covered by a layer of radiation sensitive material, providing a projection beam of radiation using an illumination system, setting a plurality of addressable elements of a programmable patterning device in accordance with a desired pattern, transferring the desired pattern onto a target portion of the layer of radiation-sensitive material using a projection system. The projection system comprises a microlens array having a plurality of microlenses corresponding to the addressable elements of the programmable patterning device and for forming an array of source images, and a projection subsystem for projecting an image of the array of source images onto the substrate.

Further embodiments, features, and advantages of the present invention, as well as the structure and operation of the various embodiments of the present invention are described in detail below with reference to accompanying drawings.

### BRIEF DESCRIPTION OF THE FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 depicts the optical system of a lithographic projection apparatus.

FIG. 2 depicts a lithographic projection apparatus, according to one embodiment of the present invention.

FIG. 3 depicts a lithographic projection apparatus, according to one embodiment of the invention.

In the Figures, corresponding reference symbols indicate corresponding parts.

### DETAILED DESCRIPTION OF THE EMBODIMENTS

Overview and Terminology

While specific configurations and arrangements are discussed, it should be understood that this is done for illustrative purposes only. A person skilled in the pertinent art will recognize that other configurations and arrangements can be used without departing from the spirit and scope of the present invention. It will be apparent to a person skilled in the pertinent art that this invention can also be employed in a variety of other applications.

More information with regard to lithographic devices as here described can be found, for example, in U.S. Pat. No. 6,046,792, which is incorporated herein by reference in its entirety.

Additional information regarding manufacturing processes can be obtained, for example, from the book “Microchip Fabrication: A Practical Guide to Semiconductor Processing”, Third Edition, by Peter van Zant, McGraw Hill Publishing Co., 1997, ISBN 0-07-067250-4, which is incorporated herein by reference in its entirety.

Also, a example microscopy and/or lithography system employing a microlens array is described in U.S. Pat. No. 6,133,986, which is incorporated herein by reference in its entirety.

The term “programmable patterning means (device)” as here employed should be broadly interpreted as referring to devices that can be used to endow an incoming radiation beam with a patterned cross-section, corresponding to a pattern that is to be created in a target portion of the substrate. The terms “light valve” and “Spatial Light Modulator” (SLM) can also be used in this context. Generally, the pattern will correspond to a particular functional layer in a device being created in the target portion, such as an integrated circuit or other device (see below). Examples of such patterning means include a programmable mirror array and a programmable LCD array.

One example of a programmable mirror array is a matrix-addressable surface having a viscoelastic control layer and a reflective surface. The basic principle behind such an apparatus is that addressed areas of the reflective surface reflect incident light as diffracted light, whereas unaddressed areas reflect incident light as undiffracted light. Using an appropriate filter, the undiffracted light can be filtered out of the reflected beam, leaving only the diffracted light behind. In this manner, the beam becomes patterned according to the addressing pattern of the matrix-addressable surface.

An array of grating light valves (GLV) can also be used in a corresponding manner. Each GLV is comprised of a plurality of reflective ribbons that can be deformed relative to one another to form a grating that reflects incident light as diffracted light.

An alternative embodiment of a programmable mirror array employs a matrix arrangement of tiny mirrors, each of which can be individually tilted about an axis by applying a suitable localized electric field, or by employing piezoelectric actuation means. Once again, the mirrors are matrix-addressable, such that addressed mirrors will reflect an incoming radiation beam in a different direction to unaddressed mirrors; in this manner, the reflected beam is patterned according to the addressing pattern of the matrix-addressable mirrors. The required matrix addressing can be performed using suitable electronic means.

In the examples described hereabove, the programmable patterning means can comprise one or more programmable mirror arrays. More information on example mirror arrays is found in U.S. Pat. Nos. 5,296,891 and 5,523,193, and PCT patent applications WO 98/38597 and WO 98/33096, which are all incorporated herein by reference in their entireties.

An example of a programmable LCD array construction is found in U.S. Pat. No. 5,229,872, which is incorporated herein by reference in its entirety.

For the sake of simplicity, the projection system can hereinafter be referred to as the “lens.” However, this term should be broadly interpreted as encompassing various types of projection systems, including, but not limited to, refractive optics, reflective optics, and catadioptric systems.

The radiation system can also include components operating according to any of these design types for directing, shaping, or controlling the projection beam of radiation. Such components can also be referred to below, collectively or singularly, as a “lens.”

Further, the lithographic apparatus can be of a type having two or more substrate tables (and/or two or more mask tables). In such “multiple stage” devices the additional tables can be used in parallel, or preparatory steps can be carried out on one or more tables while one or more other tables are being used for exposures. Example dual stage lithographic apparatus are described in U.S. Pat. No. 5,969,441 and PCT Application WO 98/40791, which are incorporated herein by reference in their entireties.

Although specific reference can be made in this text to the use of the apparatus according to the invention in the manufacture of ICs, it should be explicitly understood that such an apparatus has many other possible applications. For example, it can be employed in the manufacture of integrated optical systems, guidance and detection patterns for magnetic domain memories, liquid-crystal display panels, thin-film magnetic heads, etc. The skilled artisan will appreciate that, in the context of such alternative applications, any use of the terms “reticle,” “wafer,” or “die” in this text should be considered as being replaced by the more general terms “mask,” “substrate,” and “target portion,” respectively.

In the present document, the terms “radiation” and “beam” are used to encompass all types of electromagnetic radiation, including ultraviolet radiation (e.g. with a wavelength of 365, 248, 193, 157 or 126 nm) and EUV (extreme ultra-violet radiation, e.g. having a wavelength in the range 5-20 nm), as well as particle beams, such as ion beams or electron beams.

Exemplary Lithography Systems

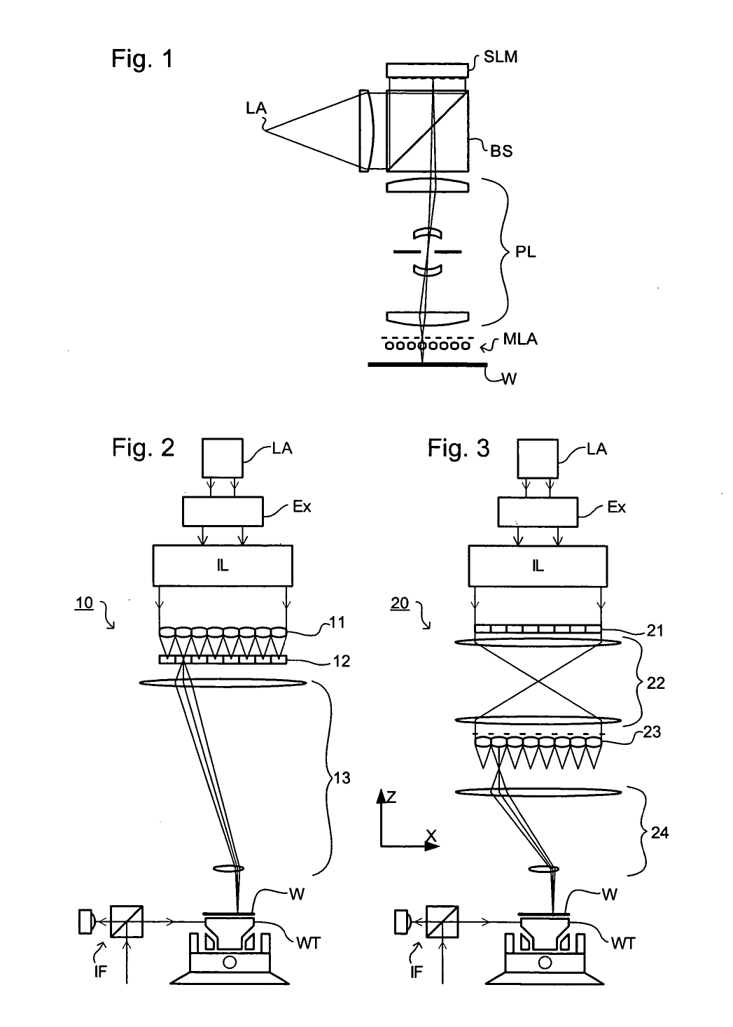

FIG. 1 shows a lithography system in which light from a light source LA is collimated and directed, via a beam splitter BS, onto a spatial light modulator SLM, constituted by a digital micro-mirror array. The individual mirrors of the spatial light modulator SLM can be set to either direct light out of the system or back through the beam splitter BS to a projection lens system PL. The projection lens system PL projects an image of the spatial light modulator SLM onto a microlens array MLA, which has microlenses in 1:1 relationship with the individual mirrors of the spatial light modulator. Each lens of the microlens array MLA images a projection aperture onto a respective spot on a substrate W. Thus, an array of spots on the substrate W can be selectively exposed according to the setting of the corresponding mirror in the spatial light modulator SLM and by scanning the substrate W, and the whole surface thereof can be selectively exposed.

FIG. 2 schematically depicts a lithographic projection apparatus 10, according to one embodiment of the present invention. Apparatus 10 comprises a radiation system, an array of microlenses 11, a programmable patterning means 12, a substrate table WT provided with a substrate holder for holding a substrate W, and a projection subsystem (“lens”) 13.

In one example, the radiation system includes a light source LA, a beam expander Ex, and an illumination system IL for supplying and processing a projection beam of radiation (e.g. UV radiation).

The array of microlenses 11 form a plurality of source images in a two-dimensional array.

In one example, the programmable patterning means 12 (e.g, an SLM) has a plurality of addressable elements corresponding to the plurality of source images formed by the array of microlenses 11.

In one example, the substrate W includes, but is not limited to, a resist-coated glass plate on which a flat panel display is to be constructed. The substrate table WT is coupled to a positioning device for accurately positioning the substrate W.

In one example, the projection subsystem (“lens”) 13 includes, but is not limited to, a quartz and/or CaF₂ lens system or a catadioptric system comprising lens elements made from such materials, or a mirror system. In this example, the projection subsystem 13 images the plurality of source images onto a target portion C of the substrate W. The target portion C includes, but is not limited to, part of one or several dies.

In one example, the source LA (e.g. an Hg lamp) produces a beam of radiation. This beam is fed into the illumination system (illuminator) IL, either directly or after having traversed conditioning device, such as the beam expander Ex, for example. The illuminator IL can comprise an adjusting device for setting the outer and/or inner radial extent (commonly referred to as σ-outer and σ-inner, respectively) of the intensity distribution in the beam. In addition, the illumination IL will generally comprise various other components, such as an integrator (not shown) and a condenser (not shown). In this way, the beam impinging on microlens array 11 has a desired uniformity, intensity distribution, and distribution of angles.

Microlens array 11 forms a plurality of source images, one per microlens in array 11, which are considerably smaller than the cross-sections of the individual microlenses. It can also be regarded as dividing the beam into a plurality of sub-beams and therefore can be replaced by another component performing that function. These source images are then projected onto the substrate W by projection subsystem 13, so as to expose an array of small, spaced-apart spots on the substrate W. In this example, projection subsystem 13 has a magnification M of 1 or less, so that the array of spots on the substrate W is the same size as or smaller than the array of source images.

The addressable elements of the programmable patterning means 12 act as individually controllable shutters for the source images, so that the spots on the substrate W can be turned OFF and ON as desired. Programmable patterning means 12 can be placed before or after the microlens array 11, but is conveniently placed close to the plane of the source images, where the pencil of rays making up each sub-beam is narrow so as to avoid absorption of the beam by inactive parts, e.g. pixel borders, of the programmable patterning means 12.

With the aid of the positioning device and interferometric measuring device IF, the substrate table WT is moved accurately to scan the substrate W under projection subsystem 13 in a scan direction, e.g. the y direction. Movement of the substrate table WT can be realized with the aid of a long-stroke module (course positioning) and a short-stroke module (fine positioning), which are not explicitly depicted in FIG. 2.

Array of microlenses 11, and hence the array of source images and the array of spots projected onto the substrate, is at an acute angle to the scan direction. In this example, the angle of array 11, its spacing, the number of rows, and the spot size are selected so that as the substrate W is scanned under the projection subsystem 13 its entire area is swept by the projected spots. In this way, the substrate W can be selectively exposed at a resolution much higher than the spacing of the source images generated by microlens array 11 without requiring projection subsystem 13 to have a very high reduction ratio.

Projection subsystem 13 can be arranged to have a relatively long focal length allowing as large a working distance between the final lens element and the substrate W as desired. To enable the size of the elements of the projection subsystem 13 to be reduced, microlens array 11 can be arranged to project the source images onto a spherical surface.

It should be noted that the source LA can be within the housing of the lithographic projection apparatus 10 (as is often the case when the source LA is a mercury lamp, for example), but that it can also be remote from the lithographic projection apparatus 10, the radiation beam which it produces being led into the apparatus (e.g. with the aid of suitable directing mirrors); this latter scenario is often the case when the source LA is an excimer laser. Both of these arrangements are contemplated within the scope of the present invention.

It is to be appreciated that, although apparatus 10 is of a transmissive type, i.e., has a transmissive programmable patterning means 12, in an alternative embodiment it can also be of a reflective type, i.e., with a reflective programmable patterning means. Also, rather than simply being an on-off shutter, programmable patterning means 12 can enable the amount of light passing through each addressable element to be controlled among a plurality of levels, or even over a continuum, to allow grayscale exposures.

FIG. 3 shows a lithographic projection apparatus 20, according to a second embodiment of the present invention. In the second embodiment, projection subsystem 13 comprises an array of microlenses 23 and first and second projection subsystems 24, 22 and programmable patterning means is positioned before projection subsystem 13. First projection subsystem 24 corresponds to projection subsystem 13 of in FIG. 2, and projects the source images generated by microlens array 21 onto the substrate W. Second projection subsystem 22 projects an image of programmable patterning means 21 onto microlens array 23, so that if an element of programmable patterning means 21 is shut, no light reaches corresponding lens in microlens array 23.

In one example, second projection system 22 can be provided with a magnification or reduction ratio to match together a programmable patterning means 21 and a microlens array 23 having different pitches. In another example, second projection system 22 has asymmetric magnification or reduction ratios if the aspect ratios of programmable patterning means 21 and microlens array 23 differ.

Conclusion

While various embodiments of the present invention have been described above, it should be understood that they have been presented by way of example, and not limitation, and that the invention may be practiced otherwise.

1. A lithographic projection apparatus, comprising:
an illumination system that supplies a projection beam of radiation;
programmable patterning device comprising a plurality of addressable elements that are set in a desired state in accordance with a desired pattern;
a projection system that transfers the desired pattern onto a target portion of a substrate, the projection system comprising,
a microlens array having a plurality of microlenses corresponding to the addressable elements of the programmable patterning device that form an array of source images; and
a projection subsystem that projects an image of the array of source images onto the substrate.

2. The apparatus of claim 1, wherein said illumination system delivers a substantially collimated beam of radiation to the microlens array which forms the array of source images therefrom, and said programmable patterning means is a selectively transmissive device positioned proximate to the microlens array whereby addressable elements of the programmable patterning devices are set to block respective ones of the source images.

3. The apparatus of claim 2, wherein the programmable patterning device is positioned substantially in an image plane of the source images.

4. The apparatus of claim 1, wherein the projection system further comprises a second projection subsystem that projects an image of the programmable patterning device onto the microlens array.

5. The apparatus of claim 4, wherein the programmable patterning device and the microlens arrays have at least one of different pitches or aspect ratios.

6. The apparatus of claim 5, wherein the second projection subsystem directs light from the addressable elements of the programmable patterning device to microlenses of the microlens array.

7. The apparatus of claim 6, wherein the second projection subsystem performs one of magnification or reduction of the directed light.

8. The apparatus of claim 1, wherein the microlens array is arranged to project the source images onto a spherical surface.

9. The apparatus of claim 1, wherein the projection subsystem projects a 1:1 or reduced image of the source image array.

10. A device manufacturing method, comprising:
setting a plurality of addressable elements of a programmable patterning device in accordance with a desired pattern;
using the programmable patterning device to pattern a beam of radiation with the desired pattern;
transferring the patterned beam of radiation onto a target portion of a layer of radiation-sensitive material on a substrate, the transferring comprising,
using a microlens array having a plurality of microlenses corresponding to the addressable elements of the programmable patterning device to form an array of source images; and
using a projection subsystem for projecting an image of the array of source images onto the substrate.
